(19) United States
(12) Patent Application Publication
(10) Pub. No.: US 2025/0205520 A1
(43) Pub. Date: Jun. 26, 2025

(54) WEARABLE AIR PURIFIER

(71) Applicant: Dyson Technology Limited, Malmesbury, Wiltshire (GB)

(72) Inventors: Duncan Jack PATTULLO, Bristol (GB); Alexander Joseph FRANCIS, Bristol (GB); Michael James LEAT, Swindon (GB); Howard Shi-How CHENG, Bristol (GB); David James HILL, Bristol (GB); Simon Brian MCNAMEE, Bristol (GB); Richard John FOX, Bristol (GB); Thomas Oliver DRYDEN, Bristol (GB)

(21) Appl. No.: 18/848,290

(22) PCT Filed: Mar. 13, 2023
(86) PCT No.: PCT/GB2023/050582

§ 371 Date: Sep. 18, 2024

(30) Foreign Application Priority Data
Mar. 22, 2022 (GB) 2203975.4

(51) Int. Cl. A62B 18/00; A62B 18/08

(52) U.S. Cl. CPC A62B 18/006; A62B 18/08

(57) ABSTRACT

A wearable air purifier that includes headgear for mounting on a wearer's head, a fan assembly operable to generate a filtered airflow, and a nozzle for directing airflow from the fan assembly, the nozzle being couplable to the headgear at opposite sides of the wearer's head to extend across a front of the wearer's head. The nozzle includes side portions located on respective sides of the central portion between the central portion and the respective point of coupling of the nozzle to the headgear, the side portions being more flexible than the central portion.

### FIELD OF THE DISCLOSURE

The present disclosure relates to a wearable air purifier.

### BACKGROUND OF THE DISCLOSURE

Air pollution is an increasing problem, and a variety of air pollutants have known or suspected harmful effects on human health. The adverse effects that can be caused by air pollution depend upon the pollutant type and concentration, and the length of exposure to the polluted air. For example, high air pollution levels can cause immediate health problems such as aggravated cardiovascular and respiratory illness, whereas long-term exposure to polluted air can have permanent health effects, such as loss of lung capacity and decreased lung function, and the development of diseases such as asthma, bronchitis, emphysema, and cancer. An approach to reducing a person's exposure to air pollution is to use a wearable air purifier to filter airflow supplied to a wearer's nose and/or mouth.

### SUMMARY OF THE DISCLOSURE

A first aspect of the present disclosure provides a wearable air purifier, comprising headgear for mounting on a wearer's head, a fan assembly operable to generate a filtered airflow, and a nozzle for directing airflow from the fan assembly, the nozzle being couplable to the headgear at opposite sides of the wearer's head to extend across a front of the wearer's head, wherein the nozzle comprises side portions located on respective sides of the central portion between the central portion and the respective point of coupling of the nozzle to the headgear, the side portions being more flexible than the central portion. The side portions are thus located between a respective point of coupling of the nozzle to the headgear and the central portion. The nozzle is thus flexible to vary a distance between points of coupling of the nozzle to the headgear.

The wearable air purifier may thus, in use, deliver filtered airflow generated by the fan assembly to the wearer's face via the nozzle. Consequently, the wearer's exposure to air pollution may desirably be reduced.

It is desirable for the nozzle to couple to the headgear at positions on either side of the wearer's head, to allow the nozzle to be well supported by the headgear, and thereby reduce unwanted movement of the nozzle relative to the headgear in use. Such good support advantageously ensures that the airflow is consistently directed by the nozzle to a desired region of the wearer's face, for example, to the lower nasal/mouth region of the wearer's face.

Coupling the nozzle to the headgear at opposite sides of the wearer's head however presents a difficulty, in that widths of wearers' heads may vary, and thus a distance between the points of coupling of the nozzle to the headgear may be expected to be variable. To accommodate such variation the nozzle should be deformable in the width dimension. An approach to facilitating such deformation is for the nozzle to be configured to be flexible, such that the nozzle can be flexed to vary the distance between the coupling points. However, excessive flexing of a central portion of the visor, the central portion being supported in front of the wearer's mouth and lower nasal region, may be undesirable, for the reason that excessive flexing of the central portion may undesirably alter the airflow characteristics of airflow discharged by the nozzle towards the wearer's face. For example, excessive flexing of the central portion of the nozzle may undesirably cause the airflow to be highly concentrated as jet, or may cause the airflow to be discharged by the visor on an undesirable trajectory, either of which undesirable characteristics may cause discomfort or irritation to the wearer.

Contrarily, in the aspect of the present disclosure, flexible side portions are provided on opposite sides of the relatively less flexible central portion, i.e., between the central portion and each point of coupling of the nozzle to the headgear. The flexible side portions may thus flex sacrificially, to achieve a desired overall degree of flex of the nozzle, whilst minimising flex of the less flexible, more rigid, central portion. Consequently, flexing of the central portion of the nozzle may be reduced, and user comfort may thereby be improved.

In examples, the headgear comprises over-the-ear style headphones. In other examples, the headgear could comprise, for example, a hat, or a headband, or another head wearable apparatus, with or without headphones.

In examples, the central portion and the side portions are defined by a continuous wall, the wall comprising a relatively rigid central region defining the central portion and relatively flexible side regions located on opposite sides of the central region defining the side portions.

In other words, the central portion and side portions may be defined, at least in part, by a unitary wall structure that extends continuously to define the central and side portions. Such a continuous wall may desirably be more mechanically durable than plural discrete wall sections that are coupled, and manufacturing complexity may additionally be reduced. Further, in examples the continuous wall may define an air guide for guiding the airflow from the fan assembly within the nozzle. In such an example, the continuous wall may desirably be less susceptible to outward leakage of the airflow than plural joined wall sections, and may present a smoother guide surface to the airflow, thereby reducing turbulence in the airflow. In other examples however the central portion and the side portions could be defined by plural discrete wall sections that are mechanically coupled.

In examples, the continuous wall is formed of a plastics material. This plastics construction may desirably be mechanically durable and resistant to fracturing even when repeatedly flexed. Additionally, plastics materials may be desirably chemically inert, and may thus advantageously minimise the extent to which airflow directed by the nozzle is contaminated.

In examples, the side regions of the wall are shorter in height than the central region of the wall. In other words, the increased flexibility of the side portions of the nozzle, compared to the central portion, may be achieved through the reduced height of the side regions. The reduced height of the side regions reduces the amount of the wall material at the side regions, thereby increasing the flexibility of those regions. This structure is desirably relatively uncomplex, thereby reducing a complexity of the manufacturing process, whilst still providing the required flexibility.

In examples, the nozzle comprises one or more auxiliary wall portions joined to an upper end of one or both of the side regions of the continuous wall and arranged to extend upwardly from the upper end of the wall, the auxiliary wall portions being more flexible than the side regions of the continuous wall.

In other words, a height of one or both of the reduced height side regions of the continuous wall may be supplemented with more flexible auxiliary wall pieces. This increased height of the side regions, to be closer in height to the height of the central region, may present a more pleasing aesthetic. Moreover, the increased height of the continuous wall and auxiliary wall portion assembly may be particularly desirable where the continuous wall serves as an air guide for guiding airflow within the nozzle, inasmuch that the greater height may better guide airflow and/or better contain airflow within the nozzle. Further, the auxiliary wall portions may desirably enable the cross-sectional area of the flow path defined by the side regions of the front wall to be increased so as to be closer to the area of the flow path defined by the central region. This uniformity in the area of the flowpath may desirably reduce turbulence in the airflow along the flowpath. Because the auxiliary wall portions are more flexible than the side regions of the wall, they do not excessively impair flexing of the side regions of the continuous wall. Thus, the height of the continuous wall may be supplemented, to provide the various above-noted advantages, without excessively reducing flexibility of the side regions of the continuous wall.

In examples, the auxiliary wall portions are moulded onto the wall. For example, the auxiliary wall portion(s) could be over-moulded onto the pre-formed continuous wall, or the continuous walls and auxiliary wall portion(s) could be formed by a two-shot moulding process. Such moulding of the auxiliary wall portions may desirably provide a mechanically durable connection between the parts. In other examples, the auxiliary wall portions could be joined to the continuous wall by an alternative method, for example, by adhering the auxiliary wall portions to the upper end of the continuous wall using an adhesive. Moulding of the auxiliary wall portions onto the wall may be inferred by an absence of adhesive.

In examples, the auxiliary wall portions may be formed of a plastics material that is more flexible than the plastics material from which the continuous wall is formed. This flexible plastics construction may desirably be mechanically durable and resistant to fracturing even when repeatedly flexed. Additionally, plastics materials may be desirably chemically inert, and may thus advantageously minimise the extent to which airflow directed by the nozzle is contaminated.

In examples, the auxiliary wall portions are arranged to extend inwardly from the upper end of the wall towards a wearer's head. In other words, the auxiliary wall portions may project from the nozzle towards the wearer's face. The auxiliary wall portions may thus desirably serve to contain air between the wall of the nozzle and the wearer's face. Moreover, because the auxiliary wall portions are more flexible than the side regions of the wall, the risk of injury/discomfort being caused to the wearer in the event of contact of the auxiliary wall portions with the wearer's face is reduced, whilst still improving the containment of the filtered airflow.

In examples, the nozzle is configured such that in an unflexed state, i.e., a relaxed state, a distance between points of coupling of the nozzle to the headgear is in the range of 13 centimetres to 19 centimetres. The present inventors have discovered that configuring the nozzle to have such a width in an unflexed state desirably allows the nozzle to fit a relatively great range of head widths with minimal flexing of the nozzle. Such minimal flexing may desirably minimise the load on couplings between the nozzle and the headgear, thereby potentially reducing mechanical degradation of the couplings. In examples, the nozzle is configured such that in an unflexed state a distance between points of coupling of the nozzle to the headgear is in the range of 15 centimetres to 17 centimetres.

A second aspect of the present disclosure provides a kit of parts for assembling a wearable air purifier, the kit comprising: headgear for mounting on a wearer's head, a fan assembly operable to generate a filtered airflow, and a nozzle for directing airflow from the fan assembly, the nozzle being couplable to the headgear at opposite sides of the wearer's head to extend across a front of the wearer's head, the nozzle comprises side portions located on respective sides of the central portion between the central portion and the respective point of coupling of the nozzle to the headgear, the side portions being more flexible than the central portion.

In other words, the wearable air purifier may be provided in plural separated parts, for example, for assembly by a wearer. For example, the nozzle may be provided separately to the headgear for coupling to the headgear by the wearer.

A third aspect of the present disclosure provides a wearable air purifier, comprising headgear for mounting on a wearer's head, a fan assembly operable to generate a filtered airflow, and a nozzle for directing airflow from the fan assembly, the nozzle being couplable to the headgear, wherein the nozzle comprises a front wall arranged to extend across a front of the wearer's head and a top wall attached to an upper end of the front wall and arranged to extend inwardly from the upper end of the front wall towards the wearer's head, and the top wall is more flexible than the front wall.

The wearable air purifier may thus, in use, deliver filtered airflow generated by the fan assembly to the wearer's face via the nozzle. Consequently, the wearer's exposure to air pollution may desirably be reduced.

The front wall may desirably serve as a guide for directing airflow from the fan assembly towards the wearer's face. The front wall may be relatively inflexible compared to the top wall. The front wall may thus desirably impart adequate structural rigidity to the nozzle to prevent excessive undesirable flexing of the nozzle in use. The top wall, projecting inwardly towards the wearer's face, may desirably improve containment of the filtered airflow between the nozzle and the wearer's face. Consequently, the degree of containment of filtered air in the region between the nozzle and the wearer's face may be improved, and thereby the wearer may be better protected from inhaling unfiltered air. Further, because the top wall is more flexible than the front wall, the top wall does not excessively impair flexing of front wall. Thus, containment of filtered airflow may be improved without excessively impairing flexing of the front wall.

Further, the enhanced flexibility of the top wall has the advantage that the wearer's face will unlikely be injured or excessively discomforted in the event that the top wall comes into contact with the wearer's face in use, e.g., in result of unintended movement of the nozzle relative to the headgear. Thus, this arrangement may desirably combine adequate structural rigidity with a high degree of containment of filtered airflow, and a reduced risk of injury or discomfort to the wearer.

In examples, the front wall is formed of a relatively rigid plastics material and the top wall is formed of a relatively flexible plastics material.

This plastics construction may desirably be mechanically durable and resistant to fracturing even when repeatedly flexed. Additionally, plastics materials may be desirably chemically inert, and may thus advantageously minimise the extent to which airflow directed by the nozzle is contaminated.

In examples, an extent to which the top wall extends inwardly from the upper end of the front towards the wearer's head may vary across the front wall. This variation in the extent of projection of the top wall allows the top wall to conform more closely to the contours of a wearer's face. This close conformance of the top wall to the wearer's face may advantageously improve the containment of filtered air in the region between the nozzle and the wearer's face, and thereby better protect the wearer from inhaling unfiltered air.

In examples, a central region of the top wall may extend inwardly towards the wearer's head to a lesser extent than side regions of the top wall that are located on opposite sides of the central region. The top wall may thereby better conform about the pronounced upper nasal region of a wearer's face. Consequently, the degree of containment of filtered air in the region between the nozzle and the wearer's face may be improved, and thereby the wearer may be better protected from inhaling unfiltered air.

In examples, the nozzle comprises an air outlet for discharging airflow from the fan assembly towards the wearer's head, and the top wall is arranged to extend along the upper end of the front wall above the air outlet. By the top wall overlying the air outlet, airflow discharged by the air outlet may be better contained in the region between the air outlet of the nozzle and the wearer's face. Consequently, the degree of containment of filtered air in the region between the nozzle and the wearer's face may be improved, and thereby the wearer may be better protected from inhaling unfiltered air.

In examples, the top wall is arranged to extend along the upper end of the front wall across at least full width of the air outlet. By the top wall overlying at least a full width of the air outlet, airflow discharged by the air outlet may be better contained in the region between the air outlet of the nozzle and the wearer's face. Consequently, the degree of containment of filtered air in the region between the nozzle and the wearer's face may be improved, and thereby the wearer may be better protected from inhaling unfiltered air.

In examples, the top wall is moulded onto the upper end of the front wall.

Such moulding of the top wall onto the front wall may desirably provide a mechanically durable connection between the parts. Moulding of the top wall onto the front wall may be inferred by the absence of adhesive. In other examples, the top wall could be joined to the front wall by an alternative method, for example, by adhering the top wall to the upper end of the front wall using an adhesive.

In examples, the nozzle comprises a bottom wall attached to a lower end of the front wall and arranged to extend inwardly from the lower end of the front wall towards the wearer's head, and the bottom wall is more flexible than the front wall.

The bottom wall, projecting inwardly towards the wearer's face, may desirably improve containment of the filtered airflow between the nozzle and the wearer's face. Consequently, the degree of containment of filtered air in the region between the nozzle and the wearer's face may be improved, and thereby the wearer may be better protected from inhaling unfiltered air.

Further, the enhanced flexibility of the bottom wall has the advantage that the wearer's face will unlikely be injured or excessively discomforted in the event that the top wall comes into contact with the wearer's face in use, e.g., in result of unintended movement of the nozzle relative to the headgear. Thus, this arrangement may desirably combine adequate structural rigidity with a high degree of containment of filtered airflow, and a reduced risk of injury or discomfort to the wearer.

In examples, the bottom wall is moulded onto the lower end of the front wall. Such moulding of the bottom wall onto the front wall may desirably provide a mechanically durable connection between the parts. In other examples, the top wall could be joined to the front wall by an alternative method, for example, by adhering the top wall to the upper end of the front wall using an adhesive.

A fourth aspect of the present disclosure provides kit of parts for assembling a wearable air purifier, the kit comprising: headgear for mounting on a wearer's head, a fan assembly operable to generate a filtered airflow, and a nozzle for directing airflow from the fan assembly, the nozzle being couplable to the headgear, wherein the nozzle comprises a front wall arranged to extend across a front of the wearer's head and a top wall attached to an upper end of the front wall and arranged to inwardly from the upper end of the front wall towards the wearer's head, and the top wall is more flexible than the front wall.

A fifth aspect of the present disclosure provides a wearable air purifier apparatus comprising: headgear for mounting on a wearer's head, a fan assembly operable to generate a filtered airflow, a nozzle for directing airflow from the fan assembly, and a coupling for movably coupling the nozzle to the headgear, wherein the coupling is configured to permit movement of the nozzle relative to the headgear about an axis between a lowered position and a raised position, and the coupling is further configured to permit movement of the nozzle relative to the headgear about a further axis, that is different to the axis, to a first range of movement when the nozzle is in the lowered position and restrict movement of the nozzle about the further axis to a second range of movement when the nozzle is in the raised position, the second range of movement being less than the first range of movement.

The wearable air purifier may thus, in use, deliver filtered airflow generated by the fan assembly to the wearer's face via the nozzle. Consequently, the wearer's exposure to air pollution may desirably be reduced.

In the raised position, the nozzle may be supported by the headgear directly in front of the mouth and lower nasal region of the wearer's face, approximately parallel to the transverse plane. In this raised position, filtered airflow discharged by the fan assembly, may be supplied by the nozzle to the wearer's face. This raised position may thus, in examples, be considered the operative position of the nozzle.

In the lowered position the nozzle may be supported by the headgear below the mouth region of the wearer's face, in an orientation nearer to parallel with the coronal plane. This lowered position may usefully allow the wearer to position the nozzle away from their mouth, which may, for example, be desirable when the wearer is conversing with another person, eating or drinking. This lowered position may thus represent an inoperative position of the nozzle.

By the coupling permitting movement of the nozzle about the axis, a wearer may thus conveniently reposition the nozzle in use.

Movement of the nozzle about the further axis may thus permit side-to-side movement of the nozzle relative to the headgear in the lowered position. Such movement of the nozzle relative to the headgear, may desirably enable the wearer to vary the orientation of the nozzle relative to the headgear in the lowered position, for example, to move the nozzle away from a position that the wearer finds obstructive.

However, it may be undesirable for the coupling to permit excessive movement of the nozzle about the further axis when the nozzle is in the raised, operative, position. Such movement about the further axis may, in the raised position, cause the wearer discomfort or irritation. Rather, in the raised, operative, position, it may be desirable for movement of the nozzle relative to the headgear about the further axis to be strictly limited, to avoid unintended movement of the nozzle in use that may cause irritation to a wearer. The coupling of this aspect of the present disclosure may thus desirably permit relative movement of the nozzle about the further axis in the lowered position, whilst desirably substantially restricting relative movement of the nozzle about the further axis in the raised position.

In examples, the coupling is movably coupled to the nozzle, such that the nozzle is movable relative to the coupling about one or both of the axis and the further axis. The coupling may then be couplable to the headgear. For example, the coupling may be releasably couplable to the headgear.

In other words, the movement of the nozzle about the axis between the lowered position and the raised position, and/or the movement of the nozzle about the further axis through the first range of movement and the second range of movement, may occur between the nozzle and the coupling, instead, for example, of between the coupling and the headgear.

This arrangement may be particularly advantageous where the nozzle is releasably couplable to the headgear, i.e., where the nozzle is configured to be fitted and removed from the headgear by the wearer in use.

In this scenario, providing the nozzle with the relatively movable coupling may desirably accommodate angular misalignment of the nozzle about the axis or the further axis relative to the headgear during coupling by the wearer of the nozzle to the headgear. In particular, by this feature, even if, during coupling, the wearer offers the nozzle to the headgear at an incorrect alignment with respect to the axis or the further axes for mating of the coupling to the headgear, such misalignment may be accommodated by movement of the coupling about the axis or the further axis relative to the headgear. Consequently the coupling may move relative to the nozzle to correctly orientate relative to the headgear for coupling to the headgear, notwithstanding that the nozzle itself may be misaligned about the axis or the further axis, for example, the nozzle may be held by the wearer in a misaligned orientation. Consequently, coupling of the nozzle to the headgear by the wearer may be simplified.

In examples, the coupling is configured such that the axis intersects the further axis. The nozzle is thus movable about both the axis and the further axis about the intersection point of the axes. Consequently, the wearer may conveniently manipulate the nozzle about both axes.

In examples, the coupling is configured such that the further axis is orthogonal to the axis. Consequently, a relatively high degree of freedom of the nozzle to move relative to the headgear is achieved.

In examples, the apparatus comprises spaced apart stops between which a portion of the nozzle is located in the raised position to thereby restrict movement of the nozzle about the further axis to the second range of movement. The stops may mechanically engage or abut the portion of the nozzle, to thereby reliably restrict the movement of the nozzle.

In examples, the coupling is configured to restrict movement of the nozzle about the further axis to a range of movement that progressively reduces from the first range of movement to the second range of movement as the nozzle is moved about the axis from the lowered position to the raised position.

This progressive reduction in the range of movement of the nozzle may desirably provide progressively increasing support to the nozzle as the nozzle is moved towards the raised position. Thus, undesired movement of the nozzle may be progressively improved.

In examples, the portion of the nozzle is located between the stops through a range of movement of the nozzle about the axis from the lowered position to the raised position, the portion of the nozzle moves between the stops as the nozzle is moved from the lowered position to the raised position, and a distance between the stops reduces in a direction parallel to the direction of movement of the portion of the nozzle between the lowered position and the raised position to thereby progressively reduce the permitted range of movement of the nozzle about the further axis as the nozzle is moved about the axis between the lowered position and the raised position.

The progressive converging of the stops may desirably facilitate smooth movement of the nozzle about the axis between the lowered and raised positions, and in particular may minimise interference by the stops with movement of the nozzle about the axis.

In examples, the coupling comprises one of an axle and a bore and the nozzle comprises the other of the axle and the bore, the axle is located in the bore, and the axle is movable in the bore about the axis and the further axis. This axle and bore construction is desirably structurally simple, and may thus benefit from simplicity of manufacture and high mechanical durability. For example, the inner diameter of the bore may be slightly oversized compared to the outer diameter of the axle to enable the relative movement about the axis and the further axis.

In examples, the nozzle is releasably movably couplable to the headgear. The wearer may thus remove the nozzle from the headgear in use. The configuration of the coupling may desirably facilitate easy coupling of the nozzle to the headgear by the wearer in use, as the coupling may advantageously accommodate misalignment between the nozzle and the headgear.

In examples, the nozzle is movably couplable to the headgear at opposite sides of the wearer's head. The nozzle may thus be better supported by the headgear, and thereby undesirable movement of the nozzle relative to the headgear in use may be further reduced.

A sixth aspect of the present disclosure provides a kit of parts for assembling a wearable air purifier, the kit comprising: headgear for mounting on a wearer's head, a fan assembly operable to generate a filtered airflow, a nozzle for directing airflow from the fan assembly, and a coupling for movably coupling the nozzle to the headgear, wherein the coupling is configured to permit movement of the nozzle relative to the headgear about an axis between a lowered position and a raised position, and the coupling is further configured to permit movement of the nozzle relative to the headgear about a further axis, that is different to the axis, to a first range of movement when the nozzle is in the lowered position and restrict movement of the nozzle about the further axis to a second range of movement when the nozzle is in the raised position, the second range of movement being less than the first range of movement.

### BRIEF DESCRIPTION OF THE DRAWINGS

In order that the present disclosure may be more readily understood, embodiments of the disclosure will now be described, by way of example, with reference to the accompanying drawings, in which:

FIGS. 1a and 1b are schematic perspective and front elevation views respectively of a wearable air purifier according to an example embodiment of the present disclosure;

FIG. 2 is a schematic exploded perspective view of the wearable air purifier previously identified with reference to FIG. 1, with a nozzle detached from headgear of the purifier;

FIG. 3 is a schematic cross-sectional view of the headgear absent the nozzle mounted on a wearer's head;

FIG. 4 is a schematic front perspective view of the nozzle;

FIG. 5 is a schematic rear perspective view of the nozzle;

FIG. 6 is a schematic top plan view of the nozzle;

FIG. 7 is a schematic front elevation view of the nozzle;

FIG. 8 is a schematic partially exploded rear perspective view of the nozzle;

FIGS. 9a and 9b are schematic perspective and front-elevation views respectively of the nozzle, in which upper and lower walls of the nozzle are detached from a front wall of the nozzle;

FIGS. 10a and 10b are schematic side and front elevation views respectively of the wearable air purifier, in which the nozzle is shown in a raised position;

FIGS. 11a and 11b are schematic side and front elevation views respectively of the wearable air purifier, in which the nozzle is shown in a lowered position;

FIG. 12 is a schematic perspective view of the nozzle showing couplings for coupling the nozzle to the headgear in detail; and

FIG. 13 is a schematic perspective view of the nozzle showing a sectional view of one of the couplings.

### DETAILED DESCRIPTION OF THE DISCLOSURE

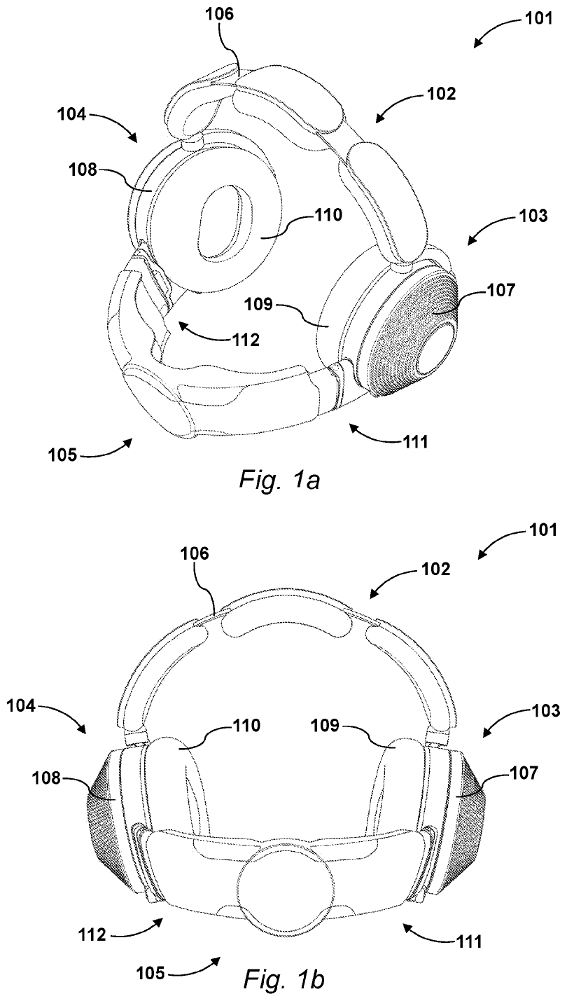

A wearable air purifier 101, embodying aspects of the present disclosure, is shown schematically in FIGS. 1a and 1b. As will be described in further detail herein, the wearable air purifier 101 is configured to be worn on a wearer's head and deliver a filtered airflow towards a lower nasal and mouth region of a wearer's face. Consequently, the wearer's exposure to ambient air pollution may desirably be reduced.

The wearable air purifier 101 comprises headgear 102 for mounting on a wearer's head, a pair of fan assemblies, indicated generally at 103 and 104, for generating filtered airflows, and a nozzle 105 for directing the airflows from the fan assemblies 103, 104 towards the lower nasal and mouth region of the wearer's face.

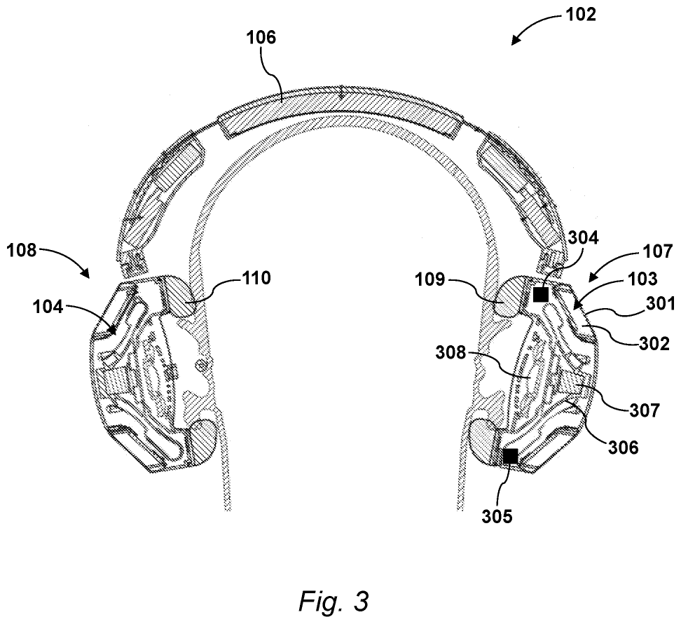

The headgear 102 has the form of “over-the-ear” headphones, and comprises a head band 106 and left and right housings 107, 108 connected to respective ends of the headband 106. The headband 106 is generally elongate and arcuate in form, and is configured to overlie a top and sides of the wearer's head in use. The left and right housings 107, 108 comprise hollow housings for housing components, such as speakers and fan assemblies 103, 104, as will be described in further detail with particular reference to FIG. 3. The housings 107, 108 comprise respective annular cushions 109, 110.

The headband 106 is formed to resiliently hold the housings 107, 108 against opposite sides, i.e., left and rights sides respectively, of the wearer's head, to thereby firmly retain the headgear 102 mounted on the wearer's head. The headband 106 is resiliently flexible to accommodate differing head widths, and the housings 107, 108 are pivotally mounted to the ends of headband 106, to facilitate pivoting of the housings 107, 108 to accommodate different head shapes.

The nozzle 105 is mechanically couplable at left and rights ends 111, 112 to a respective one of the housings 107, 108 of the headgear 102, and is configured to extend from the left and right ends 111, 112 width-wise across the wearer's face, approximately directly in front of the lower nasal and mouth region. The headgear 102 thereby supports the nozzle 105 in front of the wearer's face. In particular, in result of the coupling of the nozzle 105 to the headgear 102 on opposite, left and right, sides of the wearer's head, the nozzle 105 is well supported and less prone to unintended movement, e.g., vibration of the nozzle 105 in use. In comparison, coupling of the nozzle 105 to the headgear 102 at only one side of the wearer's head, for example, at the left end 111 only, would result in a torque being exerted on the single coupling by the mass of the nozzle, and may result in excessive undesired movement of the nozzle in use.

The nozzle 105 is configured to be flexible in a width dimension, i.e., parallel to the width dimension of the wearer's head, so as to allow a distance between the point of coupling of the nozzle 105 to the headgear 102 to be varied. This flexibility advantageously allows the nozzle 105 to accommodate differing distances between the housings 107, 108, and thus ultimately differing widths of wearers' heads.

As will be described with reference to later Figures, the nozzle 105 serves as an air guide for ducting the filtered airflows from the fan assemblies 103, 104 located in the housings 107, 108 respectively to a central region of the nozzle 105, and for discharging the airflows therefrom towards the lower nasal and mouth region of the wearer's face. In examples, the nozzle 105 is configured to not contact the wearer's face, such that it is supported by the headgear 102 a short distance in front of the wearer's face. This non-contact configuration may advantageously improve wearer comfort, inasmuch that the potential for skin irritation or other discomfort caused by contact of the nozzle 105 with the wearer's face is reduced.

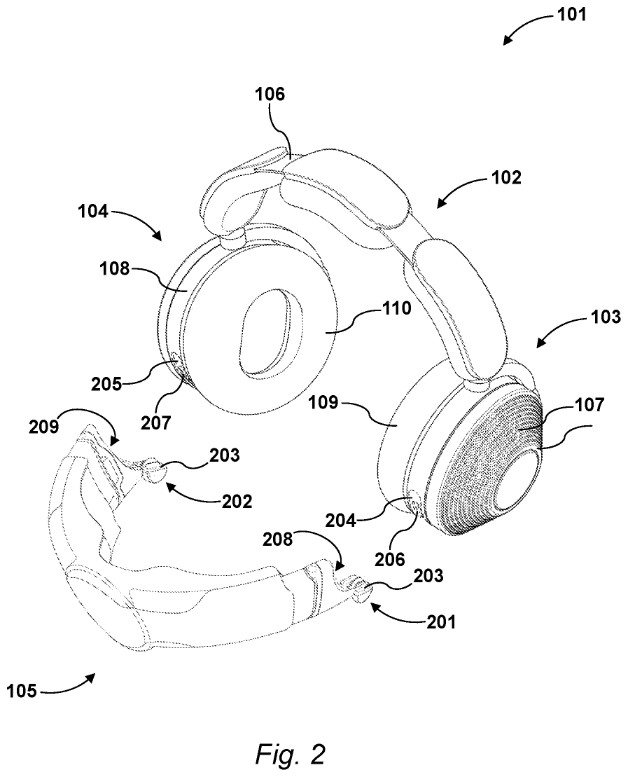

Referring next in particular to FIG. 2, in examples the nozzle 105 is releasably couplable to the headgear 102.

The nozzle 105 is releasably coupled to headgear 102 by couplings 201, 202 that are connected to left and right ends respectively of the nozzle.

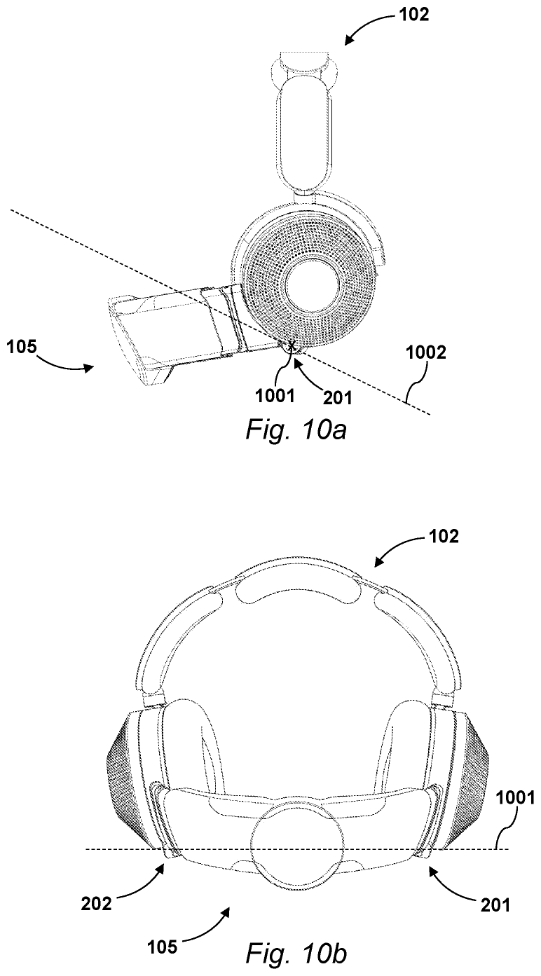

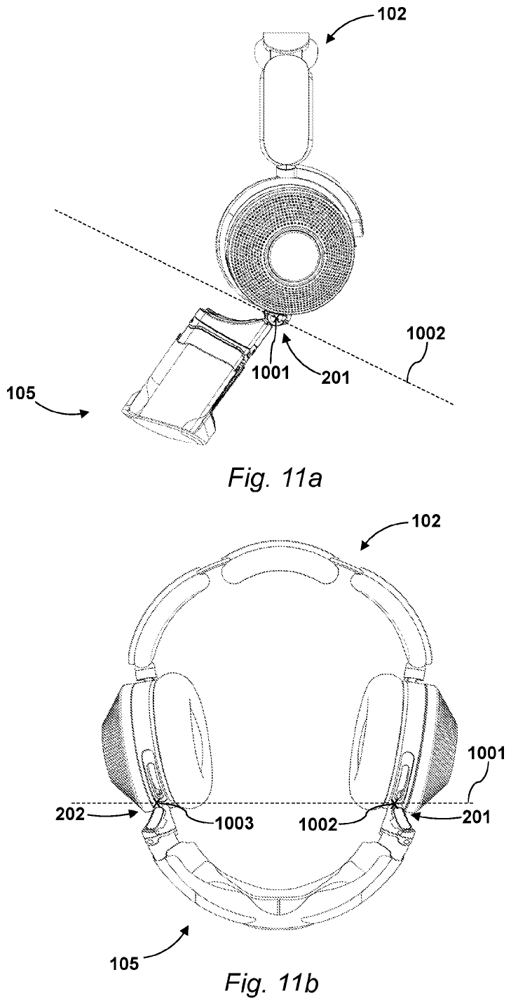

For this purpose, couplings 201, 202 are provided with magnets 203, and housings 107, 108 comprise respective magnetic regions 204, 205. Magnets 203 are attracted to magnetic regions 204, 205 to releasably couple the left and right ends 111, 112 of the nozzle 105 to the housings 107, 108 respectively. As will be described further with particular reference to FIGS. 10a to 11b, in examples, nozzle 105 is movably coupled to the headgear 102 by the couplings 201, 202, to enable movement of the nozzle 105 relative to the headgear 102. Couplings 201, 202 thus facilitate releasable, movable, coupling of left and right ends 111, 112 of the nozzle 105 to a respective one of the housings 107, 108 of the headgear 102.

The releasable coupling of the nozzle 105 to the headgear 102 allows the wearer to conveniently detach the nozzle 105 from the headgear 102. This may advantageously allow easier cleaning of the nozzle 105 separately from the headgear 102, and/or enable more dimensionally compact stowage of the headgear 102 and nozzle 105. Further, this may desirably allow easier mounting of the purifier 101 to the wearer's head, as the wearer may firstly mount the headgear 102 to their head, and subsequently couple the nozzle 105 to the pre-mounted headgear 102.

The left and right housings 107, 108 define respective outlet apertures 206, 207, in fluid communication with a respective one of the fan assemblies 103, 104, for thereby emitting filtered airflows generated by the fan assemblies 103, 104 from the housings 107, 108. Nozzle 105 comprises inlet apertures 208, 209 located on left and right ends respectively. The ends 111, 112 of the nozzle 105 and housings 107, 108 are relatively configured such that outlet apertures 206, 207 of the housings 107, 108, are in fluid communication with a respective one of inlet apertures 208, 209 of nozzle 105, when nozzle 105 is releasably coupled to headgear 102 by magnets 203 and magnetic regions 204, 205, as depicted in FIGS. 1a, 1b and 2.

In the example described in detail herein nozzle 105 is releasably coupled to headgear 102 by magnet couplings. In other examples, other releasably couplings could be employed for releasably coupling the nozzle 105 to headgear 102. For example, nozzle 105 could alternatively be releasably coupled to the headgear 102 by releasable catches or clips, or by hook and loop fasteners. In other examples, nozzle 105 could be non-releasably coupled to the headgear 102. For example, the nozzle 105 could be structurally integral with the headgear 102, and not releasable from the headgear 102.

Referring next in particular to FIG. 3, in examples the housings 107, 108 of headgear 102 contain respective fan assemblies 103, 104. Housings 107, 108 and fan assemblies 103, 104 are substantially like, and for brevity therefore only housing 107 and fan assembly 103 will be described in detail herein, on the understanding that substantially the same teachings apply to the housing 108 and fan assembly 104.

Housing 107 comprises inlet aperture(s) 301, particle filter 203, fan 303, fan controller 304, and battery 305. Fan 303 comprises a mixed-flow impeller 306 driven by an electric motor 307. Electric motor 307 is supplied with electrical power by battery 305 via fan controller 304. Fan 303 is controllable by fan controller 304 to draw air in through inlet 301, via filter 302, and discharge the filtered airflow via the outlet 206 to the nozzle 105, as described previously with reference to FIG. 2.

In the example, headgear 102 is configured such that housings 107, 108 are located over a wearer's ears, with the respective annular pad 109, 110 configured to surround the ear. In the specific example, each of housings 107, 108 is further provided with a speaker 308, operable to communicate with an external audio playback device, such that the headgear 102 may further function as headphones. Speaker 308 is also powered by battery 305. In other examples, speakers 308 may be omitted.

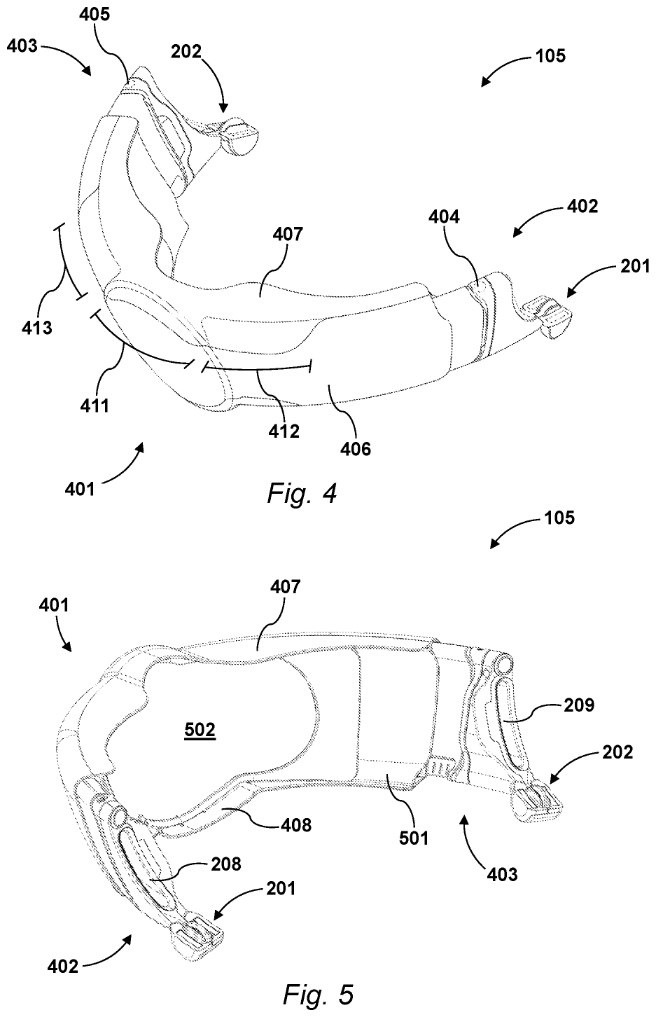

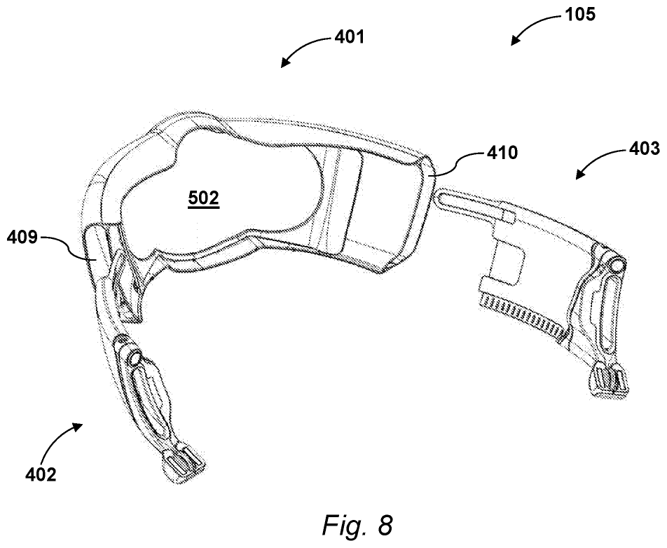

Referring next in particular to FIGS. 4 to 8 collectively, in examples nozzle 105 comprises a main body 401, and left and right arms 402, 403.

Left and right arms 402, 403 define the left and right ends 111, 112 respectively for coupling to the headgear 102, and inlet apertures 208, 209 respectively. The left and right arms 402, 403 define closed ducts for ducting airflows from the respective inlet aperture 208, 209 forwardly towards the main body 401. In examples, each of the arms 402, 403 comprises a hinged joint 404, 405. This hinged joint advantageously accommodates variation in the angle between the ends of the nozzle 105 and the housings 107, 108 of the headgear 102.

Main body 401 is generally arcuate in form, and comprises a front wall 406, top and bottom auxiliary walls 407, 408, and a rear wall 501. The main body 401 defines left and right side openings 409, 410, and an outlet aperture 502 in the rear wall 501. The walls 406, 407, 408, 501 of the main body 401 function as air guides to guide airflow from the side openings 409, 410 to the outlet aperture 502. The main body 401 of the nozzle 105 is flexible in the width dimension ‘W’. This flexibility of the main body 401 advantageously enables deformation of the nozzle 105 to vary a distance, ‘D’, between the points of coupling of the nozzle 105 to the headgear 102, and thereby allow the nozzle 105 to conform to different head widths. In example, the nozzle 105 may be constructed such that in an unflexed, rest, state the distance D between the points of coupling, i.e., the couplings 201, 202, of the nozzle 105 to the headgear is in the region of approximately 13 centimetres to approximately 19 centimetres. Configuring the nozzle 105 to have such a width in an unflexed state desirably allows the nozzle to fit a relatively great range of head widths with minimal flexing of the nozzle. In examples, the nozzle is configured such that in an unflexed state the distance D between the points of coupling of the nozzle to the headgear is in the range of 15 centimetres to 17 centimetres.

In the assembled condition shown in FIGS. 4 to 7, the left and right arms 402, 403 are partially located in the side openings 409, 410 of the main body 401 and are movable telescopically inwardly and outwardly of the main body 401. This telescopic movement of the arms 402, 403 relative to the main body 401 allows the extent to which the main body 401 projects forwardly from the headgear 102 to be increased and decreased, which may advantageously allow better fitment of the purifier 101 to wearers' heads of differing sizes and shapes.

The left and right arms 402, 403 are thus configured to support the main body 401 in front of the wearer's head, with the outlet aperture 502 of the main body 401 being located in front of and facing the lower nasal region/mouth of the wearer's face. The arms 402, 403 are configured to duct airflows from the respective fan assembly 103, 104, via the respective inlet aperture 208, 209, to the main body 401, such that the filtered airflows from the fan assemblies 103, 104 may combine in the main body 401 and be discharged from the outlet aperture 502 of the main body 401 directed towards the lower nasal/mouth region of the wearer's face.

Main body 401 comprises a central portion 411 and left and right side portions 412, 413 respectively located on opposite sides of the central portion 411 between the central portion 411 and a respective one of the ends 111, 112. The left and right side portions 412, 413 are thus located between the central portion 411 and a respective point of coupling of the nozzle 105 to the headgear 102.

A front of the central portion 411 and the left and right side portions 412, 413 are defined by the front wall 406, which extends continuously across the width of the main body 401 between the end openings 409, 410 and across the central portion 411. Top and bottom walls 407, 408 further extend continuously across a majority of the width of the main body 401. The continuously extending front wall 406 and top and bottom walls 407, 408 may advantageously aid smooth airflow between the side openings 409, 410 and the outlet aperture 502.

The front wall 406 comprises a central region 701 defining a front to the central portion 411, and side regions 702, 703 defining a front to at least part of each of the side portions 412, 413 respectively. The side regions 702, 703 are shorter in height than the central region 701. The reduced height of the side regions 702, 703 compared to the central region 701 has the result that each of the side regions 702, 703 of the front wall 406 is relatively more flexible than the central region 701 of the front wall 406, in consequence of the relatively reduced amount of material of the front wall 406 that exists at the side regions 702, 703. In examples, the front wall 406 is formed of a plastics material, for example, a nylon plastics material.

This increased flexibility of the side regions 702, 703 of the front wall 406 compared to the central region 701 has the effect that at least a respective region of each the side portions 412, 413 of the main body 401 is more flexible than the central portion 411. Consequently, flexing of the main body 401 in the width dimension ‘W’ occurs primarily at the side regions 702, 703, and hence the side portions 412, 413, whereas the central region 701, and thus the central portion 411, may tend to flex less, and thus better maintain its unflexed form. Maintenance of the form of the central portion 411 of the nozzle 105 may have advantages in terms of the characteristics of airflow discharged from the outlet aperture 502. For example, minimising flex of the central portion 411 may avoid undesirable variation of the trajectory of airflow discharged from the outlet aperture 502, and/or avoid undesirable variation in the dimensional concentration of the airflow, and in particular may desirably avoid concentration of the discharged airflow into a narrow high-velocity jet. Consequently, excessive flexing of the central portion 411 of the nozzle 105 may be avoided, and user comfort may thereby potentially be improved.

The top and bottom walls 407, 408 of the main body 401 are arranged to project inwardly from the front wall 406 towards the wearer's face. The top and bottom walls, 407, 408 are provided to improve containment of filtered airflow discharged from the outlet aperture 502 between the nozzle 105 and the wearer's face, to thereby better exclude unfiltered ambient air from the lower nasal/mouth region of the wearer's face.

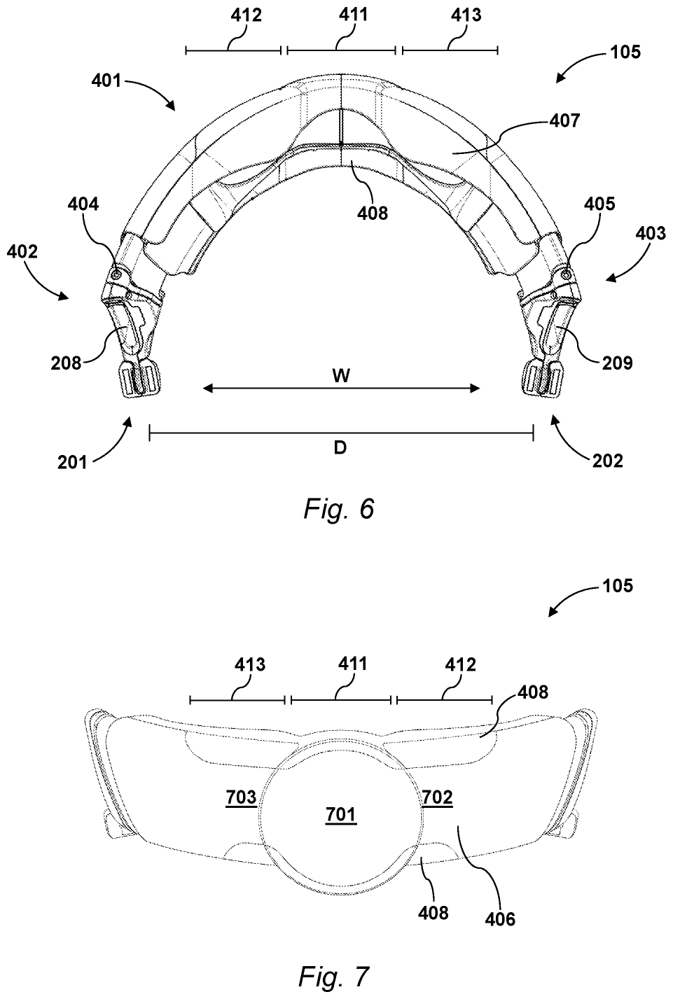

Referring in particular to FIG. 6, the extent to which the top wall 407 projects inwardly towards the wearer's face from the front wall 406 varies across the width of the main body 401. For example, a portion of the top wall 407 that extends along the top of the central region 701 of the front wall 406 projects inwardly towards the wearer's face to a relatively lesser extent than respective portions of the top wall 407 that extend along the top of each of the side regions 702, 703. This variation in the extent of projection of the top wall 407 allows the top wall 407 to conform relatively closely to the contours of a wearer's face. In particular, the reduced extent of projection of the central portion of the top wall 407 allows the top wall 407 to conform about a pronounced upper nasal region of a wearer's face. This close conformance of the top and bottom walls 407, 408 to the wearer's face may advantageously improve the containment of filtered air in the region between the nozzle 105 and the wearer's face.

In examples, the top and bottom walls 407, 408 are each formed of a resiliently flexible plastics material, for example, an elastomeric material. In examples, the top and bottom walls 407, 408 are each formed of a plastics material that is more flexible than the plastics material from which the front wall 406 is formed. This flexibility of the top and bottom walls 407, 408 advantageously serves two primary functions. Firstly, the flexibility of the top and bottom walls 407, 408 advantageously allows top and bottom walls 407, 408 to flex with the front wall 407 at the side regions 702, 703. Furthermore, the flexibility of the top and bottom walls 407, 408 has the advantage that a user will not be injured or excessively discomforted if either of the top and bottom walls 407, 408, comes into contact with the wearer's face in use.

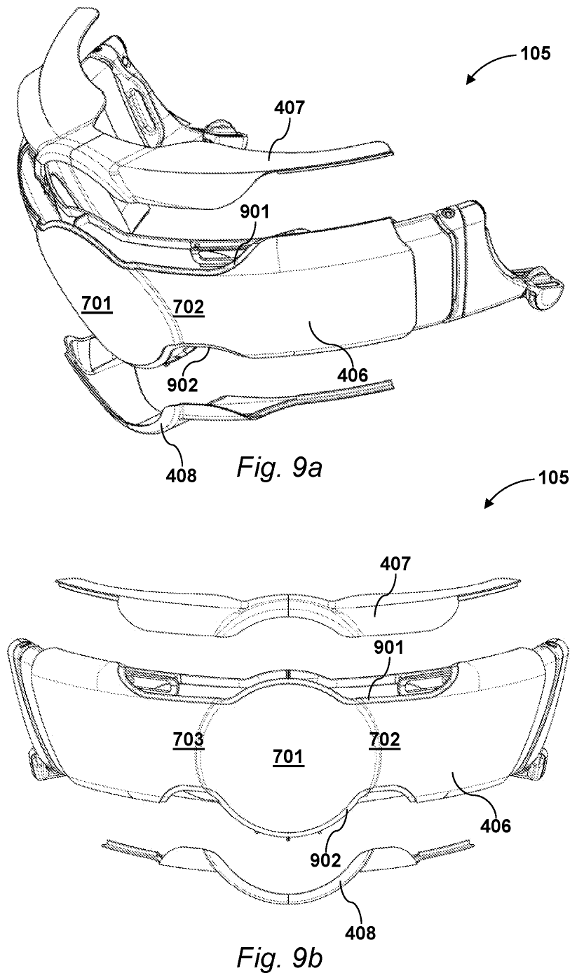

Referring next in particular to FIGS. 9a and 9b, in examples, each of top wall 407 and bottom wall 408 comprises a separate part attached to the front wall 406.

Top wall 407 is attached to an upper end 901 of the front wall 406. Top wall 407 is arranged to extend upwardly from the upper end 901 of the front wall 406, and subsequently project inwardly from the front wall 406 towards the wearer's face. Similarly, bottom wall 408 is attached to a lower end 902 of the front wall 406, and is arranged to extend downwardly from the lower end 902, and subsequently project inwardly from the front wall 406 towards the wearer's face.

In the example, each of the top wall 407 and the bottom wall 408 are arranged to extend along substantially the full width of the main body 401, thereby overlying or underlying respectively at least a full width of the air outlet 502 defined in the central portion 411 of the main body 401. Over or under-lying the full width of the air outlet 502 may desirably better contain filtered air within the volume between the nozzle 105 and the wearer's face.

By the top wall 407 extending upwardly from the upper end 901 of the side regions 702, 703 of the front wall 406, and the bottom wall 408 extending downwardly from the lower end 901 of the side regions 702, 703, the height of the side regions 702, 703 of the front wall 406 is supplemented by the top and bottom walls 407, 408. Consequently, the overall height of the side portions 412, 413, of the main body 401 is increased compared to the reduced height of the side regions 702, 703 of the front wall 406, such that the overall height of the side portions 412, 413 of the main body 401 is closer in overall height to the height of the central portion 411 of the main body 401.

This additional height provided to the side portions 412, 413 by the top and bottom walls 407, 408 may advantageously allow better containment of the filtered airflow in the volume between the nozzle 105 and the wearer's face. Further, the additional height of the side portions may desirably allow the cross-sectional area of the flow paths through the main body 401 to be maintained between the side openings 409, 410 and the outlet aperture 502. This may reduce turbulence in the airflow through the main body 401, and thus minimise generation of acoustic noise.

In examples, top wall 407 and bottom wall 408 are attached to the upper or lower end 901, 902, respectively of the front wall 406 by moulding of the part with the front wall 406. Moulding of the top and bottom walls 407, 408, with the front wall 406 may advantageously result in a relatively strong and durable, attachment of the top or bottom wall 407, 408 to the respective end of the front wall 406. In examples, the top and bottom wall 407, 408 and the front wall 406 may be formed by a two-shot injection moulding process, or alternatively the top and bottom walls 407, 408 could be over-moulded onto the front wall 406. As an example alternative, the top and bottom walls 407, 408 could be attached to the upper and lower ends 901, 902 respectively of the front wall 406 by adhesive.

Referring next in particular to FIGS. 10a, 10b, 11a and 11b, in examples, the nozzle 105 is movably coupled to the headgear 102, such that the nozzle 105 may be moved relative to the headgear 102.

The nozzle 105 is movably coupled to the headgear 102 by left and right couplings 201, 202. Thus, coupling 201 magnetically couples to left housing 107, and coupling 202 magnetically couples to right housing 108.

The couplings 201, 202 movably couple the nozzle 105 to the headgear 102, to permit movement of the nozzle 105 about an axis 1001 between raised and lowered positions.

In the raised position, depicted in FIGS. 10a and 10b, the nozzle 105 is supported by the headgear 102 directly in front of the mouth and lower nasal region of the wearer's face, approximately parallel to the transverse plane. In this raised position, filtered airflows discharged by the fan assemblies 103, 104, may be supplied by the nozzle 105 to the wearer's face. This raised position may thus be considered the operative position of the nozzle.

In the lowered position, depicted in FIGS. 11a and 11b, the nozzle 105 is supported by the headgear 102 below the mouth region of the wearer's face, in an orientation nearer to parallel with the coronal plane. This lowered position may usefully allow the wearer to move the nozzle away from their mouth, which may, for example, be desirable when the wearer is conversing with another person, eating or drinking. This lowered position may thus represent an inoperative position of the nozzle. In examples, the purifier 101 may comprise a sensor for sensing when the nozzle is in the lowered position, and a control circuit for stopping the fan assemblies 103, 104 when the nozzle 105 is sensed to be in the lowered position, to thereby cease discharge of airflow from the nozzle 105.

As will be described in further detail with reference to later Figures, in examples the couplings 201, 202 are further configured to permit movement of the nozzle 105 about further axes 1002, 1003, the further axes 1002, 1003 being mutually parallel, and approximately orthogonal to the axis 1001.

Movement of the nozzle 105 about the further axes 1002, 1003 may thus permit side-to-side movement of the nozzle 105 relative to the headgear 102. Such movement of the nozzle 105 relative to the headgear 102, may desirably enable the wearer to vary the orientation of the nozzle 105 relative to the headgear 102.

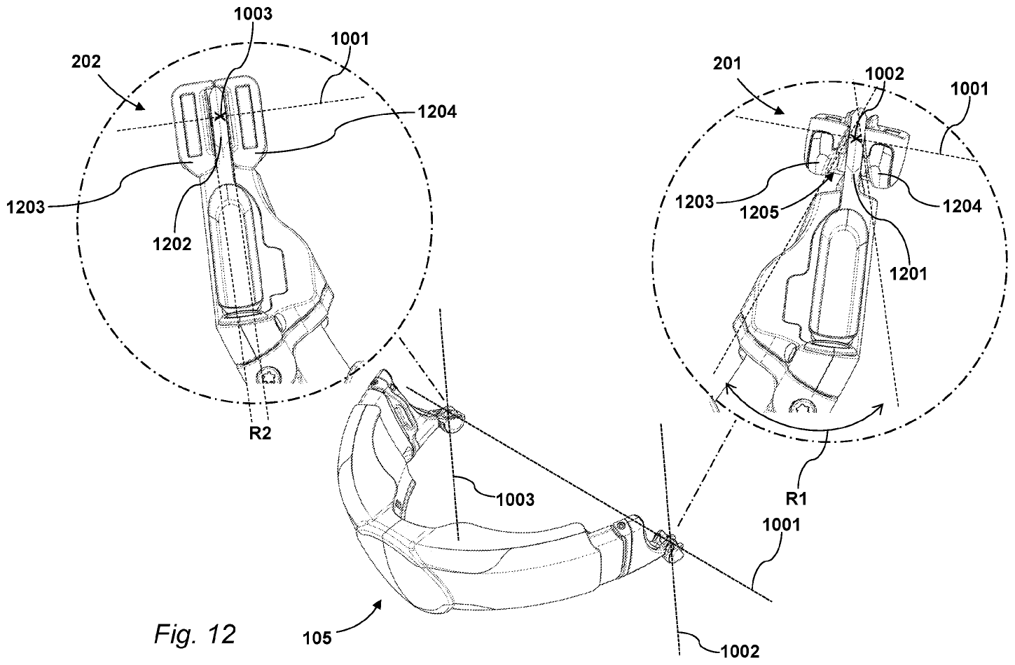

Moreover, as will be described in further detail with reference to FIG. 12, in examples the couplings 201, 202 permit relative movement of the nozzle 105 relative to the couplings about the further axes 1002, 1003. This may desirably accommodate angular misalignment of the nozzle 105 about the further axes 1002, 1003 relative to the headgear 102 during coupling by the wearer of the nozzle 105 to the headgear 102. In particular, because of this feature, even if, during coupling, the wearer offers the nozzle 105 to the headgear 102 at a modestly incorrect alignment with respect to the further axes 1002, 1003 for mating of the couplings 1002, 1003 to the headgear 102, such misalignment may be accommodated by movement of the couplings 201, 202 relative to the nozzle 105 about the further axes 1002, 1003. Consequently the couplings 201, 202 may move relative to the nozzle 105 to correctly align with the coupling regions 204, 205 of the housings 107, 108, notwithstanding that the nozzle 105 itself may be misaligned about the further axes 1002, 1003. Consequently, coupling of the nozzle 105 to the headgear 102 by the wearer may be simplified.

However, whilst in examples it is desirable for the couplings 201, 202 to permit movement of the nozzle 105 relative to the headgear 102 about the further axes 1002, 1003, e.g., to facilitate easier coupling of the nozzle 105 to the headgear 102, it may be undesirable for the nozzle 105 to be movable about the further axes 1002, 1003 when the nozzle 105 is in the raised, operative, position, depicted in FIGS. 10a and 10b. Rather, in the raised, operative, position, it may be desirable for movement of the nozzle 105 relative to the headgear 102 about the further axes 1002, 1003 to be strictly limited, to avoid unintended movement of the nozzle 105 in use that may cause irritation to a wearer.

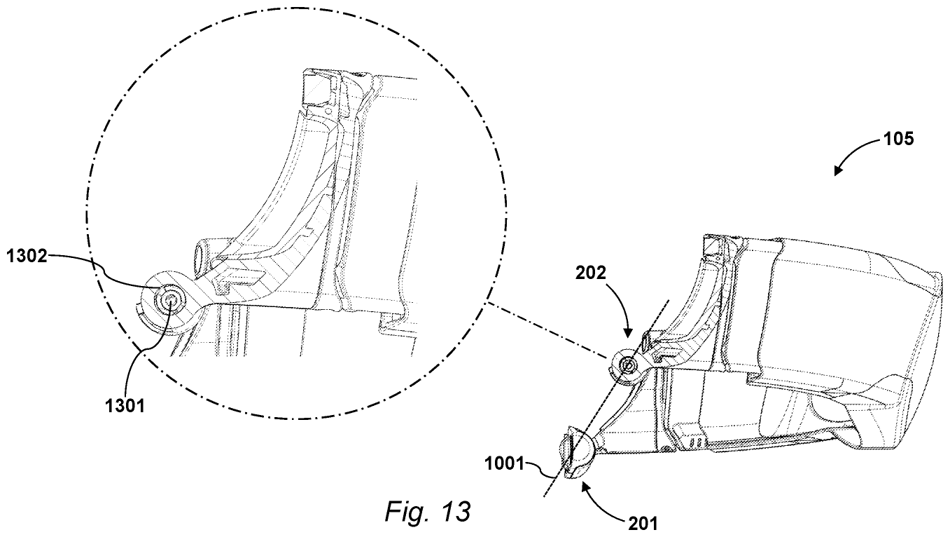

Referring next in particular to FIGS. 12 and 13, in examples, the couplings 201, 202 are movably coupled to left and right end portions 1201, 1202 of the nozzle 105. In FIG. 12, right coupling 202 is shown in an orientation about the axis 1001 corresponding to the nozzle 105 being in the raised position relative to the headgear 102. For comparison purposes, left coupling 201 is shown relatively rotated about the axis 1001 corresponding to the nozzle 105 being in the lowered position relative to the headgear 102. The left and right couplings 201, 202, and the coupling of the couplings 201, 202 to the respective end portion 1201, 1202 of the nozzle 105 and to the headgear 102 are substantially the same.

Each coupling 201, 202 defines an axle 1301, extending along and defining the axis 1001.

Each of the left and right end portions 1201, 1202 of the nozzle 105 comprises a bore 1302. The axles 1301 of the couplings 201, 202 are located in a respective one of the bores 1302, to thereby couple the couplings 201, 202 to a respective one of the left and right end portions 1201, 1202 of the nozzle 105. The axles of the couplings and the bores of the nozzle are relatively sized to permit movement of the end portions 1201, 1202 of the nozzle 105 relative to the couplings 201, 202 about the axis 1001 and a respective one of the further axes 1002, 1003. In particular, the inner diameter of the bores 1302 is modestly larger than the outer diameter of the axles 1301, such that the end portions 1201, 1202 of the nozzle 105 are relatively loosely coupled to the couplings 201, 202, to thereby facilitate movement of the end portions 1201, 1202 of the nozzle 105 relative to the couplings 201, 202 about the further axes 1002, 1003 respectively.

Referring in particular to the illustration of the left coupling 201 each coupling part 201, 202 comprises a pair of spaced apart stops 1203, 1204. The stops 1203, 1204 are spaced apart either side of the further axes 1002, 1003, and the respective end portion 1201, 1202 of the nozzle 105 is located between the stops 1203, 1204. The stops 1203, 1204 thus limit movement of the coupling 201, 202 relative to the respective end portion 1201, 1202, of the nozzle 105 about the respective further axes 1002, 1003, and so limit movement of the nozzle 105 relative to the headgear 102 about the further axes 1002, 1003.

The stops 1203, 1204 extend in an angular linear direction orbitally about axis 1001, and thus define a channel 1205 extending in the angular linear direction in a direction of movement of the respective end portion 1201, 1202, of the nozzle 105 relative to the coupling 201, 202 as the nozzle 105 is moved between the lowered and raised positions. The width of the channel 1205, i.e., the distance between the stops 1203, 1204, progressively reduces in the direction of the movement of the end portion 1201, 1202 of the nozzle 105 along the channel 1205 between the lowered and raised positions. Thus, a degree of freedom of the end portions 1201, 1202 of the nozzle 105 to move about a respective one of the further axes 1002, 1003 reduces progressively as the nozzle 105 is moved relative to the couplings 201, 202 between the lowered orientation and the raised orientation.

Thus, referring to the depiction of left coupling 201 in FIG. 12, in the lowered position, due to the relative great distance between the stops 1203, 1204, the end portion 1201 of the nozzle 105 is movable relative to the coupling 201 about the further axis 1002 through a relatively great range of movement, ‘R1’. In the illustrated example, the end portion 1201 of the nozzle 105 is movable relative to the coupling 201 about the further axis 1002 through a range of movement of approximately 40 degrees. Thus, in this relative orientation between the end portion 1201 of the nozzle 105 and the coupling 201, corresponding to the lowered position of the nozzle 105, the nozzle 105 is movable relative to the coupling 201 about the further axis 1002 through a relatively great range of movement, such that a relatively great degree of misalignment between the coupling 201 and the magnetic region 204 of the housing 107, e.g., approximately 20 degrees in either direction about the axis 1002, may be accommodated during coupling by the wearer of the nozzle 105 to the headgear 102.

In contrast, referring to the depiction of the right coupling 202 in FIG. 12, in the raised position, due to the relatively lesser spacing between the stops 1203, 1204, the end portion 1202 of the nozzle 105 is movable relative to the coupling 202 about the further axis 1003 only through a relatively smaller range of movement, ‘R2’. In particular, in this orientation of the coupling 202, relative to the end portion 1202 of the nozzle 105, the stops 1203, 1204 of the coupling 202 both abut the end portion 1202, thus restricting movement of the end portion 1202 relative to the coupling 1202 to a near-zero range of movement. Thus, in this relative orientation between the end portion 1202 of the nozzle 105 and the coupling 202, corresponding to the raised position of the nozzle 105, movement of the nozzle 105 relative to the coupling 202 about the further axis 1003 is substantially prevented, such that in the raised position the nozzle 105 is supported stably by the headgear 102, and side-to-side movement of the nozzle 105 relative to the headgear is substantially prevented. Accordingly, undesirable side-to-side movement of the nozzle 105 relative to the headgear 102 in use may be avoided. In examples, it is desirable that the permitted range of movement, R2, in the raised position is reduced as far as practicable, to best support to the nozzle 105 in the raised position.

1. A wearable air purifier, comprising:
headgear for mounting on a wearer's head,
a fan assembly operable to generate a filtered airflow, and
a nozzle for directing airflow from the fan assembly, the nozzle being couplable to the headgear at opposite sides of the wearer's head to extend across a front of the wearer's head, wherein
the nozzle comprises side portions located on respective sides of a central portion between the central portion and a respective point of coupling of the nozzle to the headgear, the side portions being more flexible than the central portion.

2. The wearable air purifier of claim 1, wherein the central portion and the side portions are defined by a continuous wall, the wall comprises a relatively rigid central region defining the central portion and relatively flexible side regions located on opposite sides of the central region defining the side portions.

3. (canceled)

4. The wearable air purifier of claim 2, wherein the side regions of the continuous wall are shorter in height than the central region of the wall.

5. The wearable air purifier of claim 2, wherein the nozzle comprises one or more auxiliary wall portions joined to an upper end of one or both of the side regions of the continuous wall and arranged to extend upwardly from the upper end of the wall, the auxiliary wall portions being more flexible than the side regions of the wall.

6. The wearable air purifier of claim 5, wherein the auxiliary wall portions are moulded onto the continuous wall.

7. The wearable air purifier of claim 5, wherein the auxiliary wall portions are formed of a plastics material that is more flexible than the plastics material from which the continuous wall is formed.

8. The wearable air purifier of claim 5, wherein the auxiliary wall portions are further arranged to extend inwardly from the upper end of the continuous wall towards a wearer's head.

9. The wearable air purifier of claim 1, wherein the nozzle is configured such that in an unflexed state a distance between points of coupling of the nozzle to the headgear ranges from 13 centimetres to 19 centimetres.

10. A kit of part for assembling a wearable air purifier, the kit comprising:
headgear for mounting on a wearer's head, the headgear comprising a fan assembly operable to generate an airflow,
a filter for filtering airflow generated by the fan assembly,
a nozzle for directing airflow from the fan assembly, the nozzle being couplable to the headgear at opposite sides of the wearer's head to extend across a front of the wearer's head, wherein
the nozzle comprises side portions located on respective sides of a central portion between the central portion and a respective point of coupling of the nozzle to the headgear, the side portions being more flexible than the central portion, and
a coupling for moveably coupling the nozzle to the headgear, wherein
the coupling is configured to permit movement of the nozzle relative to the headgear about an axis between a lowered position and a raised position, and
the coupling is further configured to permit movement of the nozzle relative to the headgear about a further axis, that is different to the axis, to a first range of movement when the nozzle is in the lowered position and restrict movement of the nozzle about the further axis to a second range of movement when the nozzle is in the raised position, the second range of movement being less than the first range of movement.

11. (canceled)

12. (canceled)

13. (canceled)

14. (canceled)

15. (canceled)

16. (canceled)

17. (canceled)

18. (canceled)

19. (canceled)

20. (canceled)

21. A wearable air purifier, comprising:
headgear for mounting on a wearer's head,
a fan assembly operable to generate a filtered airflow,
a nozzle for directing airflow from the fan assembly, and
a coupling for movably coupling the nozzle to the headgear, wherein
the coupling is configured to permit movement of the nozzle relative to the headgear about an axis between a lowered position and a raised position, and
the coupling is further configured to permit movement of the nozzle relative to the headgear about a further axis, that is different to the axis, to a first range of movement when the nozzle is in the lowered position and restrict movement of the nozzle about the further axis to a second range of movement when the nozzle is in the raised position, the second range of movement being less than the first range of movement.

22. The wearable air purifier of claim 21, wherein the coupling is movably coupled to the nozzle, such that the nozzle is movable relative to the coupling about one or both of the axis and the further axis.

23. The wearable air purifier of claim 21, wherein the coupling is configured such that the axis intersects the further axis and the further axis is orthogonal to the axis.

24. (canceled)

25. The wearable air purifier of claim 21, comprising spaced apart stops between which a portion of the nozzle is located in the raised position to thereby restrict movement of the nozzle about the further axis to the second range of movement.

26. The wearable air purifier of claim 21, wherein the coupling is configured to restrict movement of the nozzle about the further axis to a range of movement that progressively reduces from the first range of movement to the second range of movement as the nozzle is moved about the axis from the lowered position to the raised position.

27. The wearable air purifier of claim 25, wherein the portion of the nozzle is located between the stops through a range of movement of the nozzle about the axis from the lowered position to the raised position, the portion of the nozzle moves between the stops as the nozzle is moved from the lowered position to the raised position, and a distance between the stops reduces in a direction parallel to the direction of movement of the portion of the nozzle between the lowered position and the raised position to thereby progressively reduce the permitted range of movement of the nozzle about the further axis as the nozzle is moved about the axis between the lowered position and the raised position.

28. The wearable air purifier of claim 21, wherein the coupling comprises one of an axle and a bore, and the nozzle comprises the other of the axle and the bore, the axle is located in the bore, and the axle is movable in the bore about the axis and the further axis.

29. The wearable air purifier of claim 21, wherein the nozzle is releasably movably couplable to the headgear.

30. The wearable air purifier of claim 21, wherein the nozzle is movably couplable to the headgear at opposite sides of the wearer's head.

31. (canceled)

32. The wearable air purifier of claim 1, wherein the nozzle is configured such that in an unflexed state a distance between points of coupling of the nozzle to the headgear ranges from 15 centimetres to 17 centimetres.

33. The wearable air purifier of claim 28, wherein an inner diameter of the bore is slightly oversized compared to an outer diameter of the axle to enable the relative movement about the axis and further axis.
